(19) United States
(12) Patent Application Publication
(10) Pub. No.: US 2012/0112426 A1
(43) Pub. Date: May 10, 2012

(54) Multi-Purpose Chassis Member

(76) Inventor: Mark Werner Volkmann, San Anselmo, CA (US)

(21) Appl. No.: 12/943,233

(22) Filed: Nov. 10, 2010

(51) Int. Cl. B62D 33/00

(52) U.S. Cl. 280/107; 296/181.1

(57) ABSTRACT

The presently disclosed embodiments, as well as features and aspects thereof, are directed towards providing a modular cart system operable in multiple configurations suitable for multiple transport applications and, more particularly, for a modular cart system that includes a multi-purpose chassis member. Advantageously, embodiments of a multi-purpose chassis member include various features that provide for either the receipt of a component included in a modular cart system or, alternatively, mechanical coupling to fixtures that are exclusive from the modular cart system. Importantly, because a multi-purpose chassis member is configured for the receipt of various components that may or may not be comprised within a given cart arrangement, a modular cart system that includes a multi-purpose chassis member can be reconfigured for a custom transport solution depending on application. That is, unlike typical cart devices, a modular cart system that includes a multi-purpose chassis member can be configured and reconfigured to take the form of a cart that is most desirable or advantageous to the user.

### BACKGROUND

Most would agree that the wheel has become the icon for man's ingenuity. The mother of all inventions, if you will. But, should it be? After all, a wheel is of little use without an axle. Considering this, perhaps it is the thought of the humble axle that should inspire man to innovate and improve. Of course, when one takes time to ponder the endless usefulness of wheels coupled to axles, the question begs as to whether either landmark innovation deserves all the attention. After all, what good is a pair of wheels and an axle without a chassis mounted on top? Regardless of where the accolades should land individually, it is the resulting combination of wheels, axle and chassis—i.e., the tried and true cart, wagon or trailer—that is the real star.

Carts, wagons and trailers have been around for millenniums, working hard to make man's life easier, if not more productive. Along the way, countless improvements have been made to the various members or components that comprise a cart. Wheels have been made of rubber, to provide longer wear and a smoother ride. Axles have been modified to include bearings, to lessen friction with the wheel. And chassis designs have been expanded to include springs that soften the cargo ride and hitches that connect to a towing means. And those are but a small sample of the improvements that have been made to the familiar components comprised within a cart.

Likewise, seemingly endless configurations of the cart itself have been offered for as many different applications. Some carts have even been designed with multiple applications in mind, configured such that a given embodiment may be transformed into various states. For instance, in an effort to provide one cart that is well suited for many applications, inventors have devised carts operable to transform from one configuration or state to another. Transformable cart embodiments may take the form of a wagon in one state, a chair in another state and a table in a third state.

The common factor among transformable carts, regardless of a given cart's particular design or functionality, is that a given member comprised within the cart will be repurposed depending on the state of configuration. For example, a component operable as a bed when in a “wagon” state may be operable as a “seat back” in a chair state. Similarly, a chassis member operable to support a wagon bed in a “wagon” state may become an armrest in a chair state.

Regardless of whether a cart, wagon or trailer takes the traditional form of a chassis rigidly fixed to a set of wheels and an axle or the more trendy form of a chassis, wheels and axle combination that is transformable into multiple configurations, the various members comprised within a given embodiment serve a single purpose when in a transport state. That is, even in the transformable embodiments, the cart state can only take on one configuration because the comprised components are configured for one purpose. As such, carts, wagons and trailers known in the art are most useful only in the particular transport applications for which each was designed.

Therefore, what is needed in the art of carts, wagons and trailers is a modular cart system that can be custom configured for specific transport applications. Further, what is needed in the art is a modular cart system comprising a multi-purpose chassis member.

### BRIEF SUMMARY

The presently disclosed embodiments, as well as features and aspects thereof, are directed towards providing a modular cart system operable in multiple configurations suitable for multiple transport applications and, more particularly, for a modular cart system that includes a multi-purpose chassis member. Advantageously, embodiments of a multi-purpose chassis member include various features that provide for either the receipt of a component included in a modular cart system or, alternatively, mechanical coupling to fixtures that are exclusive from the modular cart system. Importantly, because a multi-purpose chassis member is configured for the receipt of various components that may or may not be comprised within a given cart arrangement, a modular cart system that includes a multi-purpose chassis member can be reconfigured for a custom transport solution depending on application.

That is, unlike typical cart devices, a modular cart system that includes a multi-purpose chassis member can be configured and reconfigured to take the form of a cart that is most desirable or advantageous to the user. Notably, while the term “cart” is often used in the present specification to refer to the various configurations that a given embodiment of a modular cart system having a multi-purpose chassis member may take, it will be understood that the scope of a modular cart system, or any system that includes a multi-purpose chassis member, will not be limited to “cart” configurations. It is envisioned that embodiments including a multi-purpose chassis member will be directed toward wagons, trailers, motorized apparatuses or any other mode of transport.

A multi-purpose chassis member may be configured for the receipt of an axle. More particularly, a multi-purpose chassis member may include features or aspects that enable the multi-purpose chassis member to be quickly coupled and decoupled from an axle component. When coupled to an axle component having wheels, for example, a multi-purpose chassis member will provide for the receipt of other components suitable for a particular purpose or transport application. As an example, one embodiment of a multi-purpose chassis member may be configured to receive vertical cargo support members that are capable of supporting a particular object such that, when the chassis member is coupled to an axle with wheels, the particular object can be transported.

As a more specific example, an embodiment of a multi-purpose chassis member may be configured for receipt of a component that is suited for retention of a bicycle. Such a component, for example, may be a channel or bracket that can be fixedly received by a multi-purpose chassis member so that a bicycle can be subsequently coupled to the component. The embodiment of the exemplary multi-purpose chassis member may also receive a hitch component and then be coupled to an axle with wheels so that the bicycle can be pulled to another location. Alternatively, the same embodiment of a multi-purpose chassis member may be decoupled from the hitch component and the axle and wheels and then mounted to a larger trailer flatbed, truck bed, luggage rack or the like such that the bicycle, safely secured to the exemplary channel component, can be transported.

As another example of a modular cart system that includes a multi-purpose chassis member embodiment, it is envisioned that two multi-purpose chassis members may be coupled to an axle and wheels and slidably positioned along the axle at a predetermined, or selected, distance apart. The exemplary chassis members, being configured for receipt of vertical cargo support components, may each receive two vertical cargo support components at either distal end of the chassis member. Subsequently, the corresponding vertical cargo support components may be communicatively coupled by a strap, or other mechanism, such that an object may be suspended and supported via the straps. For illustrative purposes only, such an embodiment of a modular cart system may be suitable for transport of a kayak or canoe, wherein the kayak or canoe can be saddled via the aforementioned straps. Advantageously, the exemplary canoe may be pulled via a hitch component of the modular cart system to wherever the user desires.

Expanding on the exemplary embodiment described above in relation to canoe transport, the same embodiment may be configured such that the vertical cargo support components and straps can be removed. Subsequently, the same embodiment of the modular cart system may be configured to receive the bicycle channels described above relative to a different embodiment. As such, one skilled in the art will understand that the modular cart system can leverage the multi-purpose chassis member such that the system can be changed between configurations ideally suited for different transport applications.

Another embodiment of a modular cart system may be configured for receipt of sled or ski components in lieu of an axle/wheel component. Such an embodiment would advantageously provide a user with the option of configuring a transport solution according to applications ranging from asphalt roads to snowy trails. Additionally, embodiments of a modular cart system that include a multi-purpose chassis member may provide a user with the option of configuring a transport solution for pulling by ATV, vehicle, sled dog team or whatever means available.

Regardless of the particular embodiment of a modular cart system that may be used, it is a common aspect among all embodiments that a multi-purpose chassis member will be included. One skilled in the art will understand that the multi-purpose chassis member provides a user of a modular cart system with a means for selecting and configuring various components that are best suited for a specific transport application. Further, various components that may be included in a modular cart system embodiment, and received by a multi-purpose chassis member, in order to best configure a transport solution for a particular transport application will occur to those with skill in the art. As such, the particular embodiments, component combinations, transport solutions or cart configurations described in this application are offered for illustrative purposes only and will not be interpreted to limit the scope or application of a modular cart system which includes a multi-purpose chassis member.

### BRIEF DESCRIPTION OF THE SEVERAL VIEWS OF THE DRAWING

FIG. 1 depicts an exemplary embodiment of a multi-purpose chassis member.

FIGS. 2A-2C illustrate top, back and side views, respectively, of an exemplary strap carrier transport solution configured from a modular cart system comprising a multipurpose chassis member.

FIGS. 3A-3C illustrate top, back and side views, respectively, of an exemplary scupper carrier transport solution configured from a modular cart system comprising a multipurpose chassis member.

FIGS. 4A-4C illustrate top, side and front views, respectively, of an exemplary beach cart transport solution configured from a modular cart system comprising a multipurpose chassis member.

FIGS. 5A-5C illustrate top, back and side views, respectively, of an exemplary 2-wheel utility cart transport solution configured from a modular cart system comprising a multipurpose chassis member.

FIGS. 6A-6C illustrate top, side and front views, respectively, of an exemplary trishaw cart transport solution configured from a modular cart system comprising a multipurpose chassis member.

FIGS. 7A-7C illustrate top, side and front views, respectively, of an exemplary 2-wheel trailer utility cart transport solution configured from a modular cart system comprising a multipurpose chassis member.

FIGS. 8A-8C illustrate top, side and front views, respectively, of an exemplary 2-wheel trailer utility cart transport solution configured from a modular cart system comprising a multipurpose chassis member.

FIGS. 9A-9C illustrate top, side and front views, respectively, of an exemplary tricycle cart transport solution configured from a modular cart system comprising a multipurpose chassis member.

FIGS. 10A-10C illustrate top, side and front views, respectively, of an exemplary moving cart transport solution configured from a modular cart system comprising a multipurpose chassis member.

FIG. 11 illustrates an exemplary golf bag transport solution configured from a modular cart system comprising a multipurpose chassis member.

FIGS. 12A-12C illustrate top, side and front views, respectively, of an exemplary 4-wheel utility cart transport solution configured from a modular cart system comprising multipurpose chassis members.

FIGS. 13A-13B illustrate top and side views, respectively, of an exemplary furniture dolly transport solution configured from a modular cart system comprising multipurpose chassis members.

FIGS. 14A-14C illustrate top, side and front views, respectively, of an exemplary steerable go-cart transport solution configured from a modular cart system comprising multipurpose chassis members.

FIGS. 15A-15B illustrate top and side views, respectively, of an exemplary luggage rack transport solution configured from a modular cart system comprising multipurpose chassis members.

FIGS. 16A-16B illustrate top and side views, respectively, of an exemplary luggage rack transport solution configured from a modular cart system comprising multipurpose chassis members.

### DETAILED DESCRIPTION

The presently disclosed embodiments, as well as features and aspects thereof, are directed towards providing a modular cart system that can be custom configured for specific transport applications by leveraging a multi-purpose chassis member (MPCM). Exemplary embodiments of an MPCM are disclosed herein in the context of carts, wagons and trailers, however, one of ordinary skill in the art will understand that various embodiments may also comprise any combination of features and aspects useful for other applications related to, but not limited to, motorized vehicles, man-powered transportation modes, cargo carriers, luggage transport systems, etc. Moreover, as most of the described embodiments are disclosed in the context of carts, wagons and trailers, one of ordinary skill in the art will understand that the reference to a “cart” in this description is not intended to limit the use of a MPCM to be in conjunction with a cart, wagon or trailer embodiment. Rather, the terms cart, wagon, trailer or other term used to generally label a disclosed embodiment will be understood to anticipate any modular cart system comprising at least one MPCM. As such, the description herein of embodiments specifically configured for cart-like transport solutions will not be interpreted to limit the scope of a MPCM.

As has been described, a MPCM may be configured for the receipt of an axle. More particularly, a MPCM may include features or aspects that enable it to be quickly coupled and decoupled from an axle component. When coupled to an axle component having wheels, for example, a MPCM will provide for the receipt of other components suitable for a particular purpose or transport application. Further, it is envisioned that some embodiments of a MPCM may be configured for the receipt of other components made of readily accessible or standard building materials such as, but not limited to, various lumber products, PVC piping, rebar, angle iron, channel, bolts, clips, etc.

Turning now to the figures, where like reference numerals represent like elements throughout the drawings, various aspects, features and embodiments of a multi-purpose chassis member (MPCM), and modular systems comprising one or more MPCMs, will be presented in more detail. The examples as set forth in the drawings and detailed description are provided by way of explanation and are not meant as limitations on the scope of a MPCM, the methods for using a MPCM or the transport solutions that may be generated by a modular cart system comprised of a MPCM. A MPCM thus includes any modifications and variations of the following examples as come within the scope of the appended claims and their equivalents.

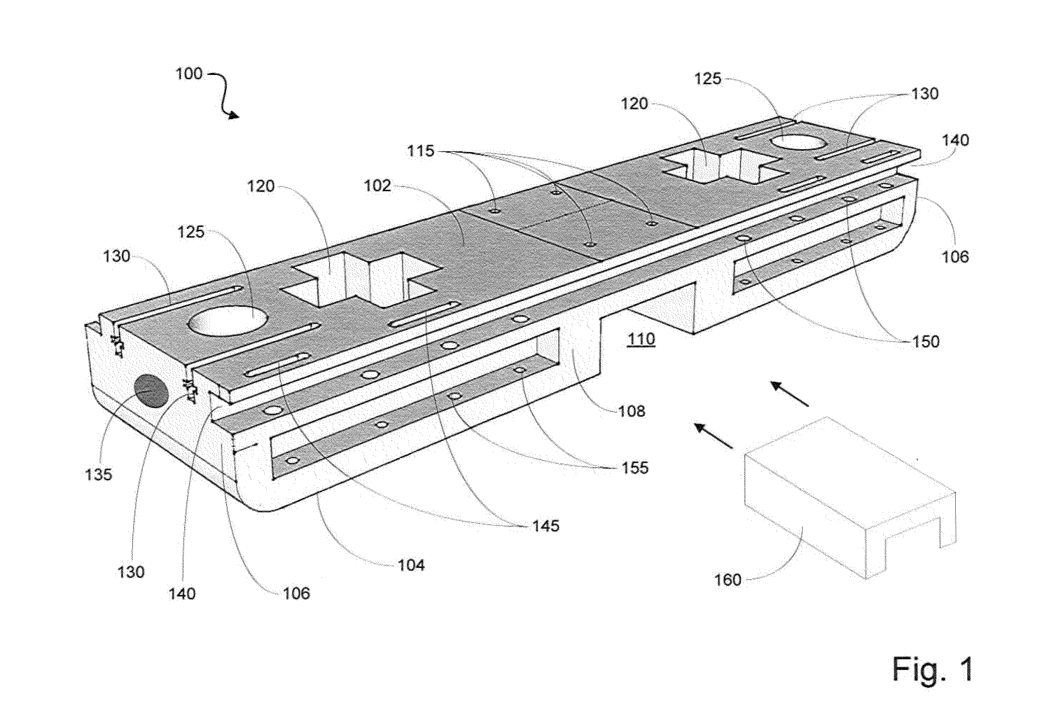

FIG. 1 depicts an exemplary embodiment of a multi-purpose chassis member (MPCM) 100. Although not required in all embodiments of a MPCM, the exemplary MPCM 100 is manufactured from a single stock having a top surface 102, a bottom surface 104 (not shown), front and back surfaces 106 (front not shown), and left-side and right-side surfaces 108 (left-side not shown). The MPCM may be constructed from any material suitable for a given transport application including, but not limited to, wood, aluminum, cast iron, steel, plastics, etc. Importantly, while the exemplary MPCM 100 is depicted such that the features and aspects to be described are symmetrical, it is envisioned that some embodiments of an MPCM will not be as such. The particular combination and placement of features in a MPCM embodiment may driven by the need for various configurations of transport solutions and may be novel in and of itself; however, the scope of a MPCM will not be limited by any particular combination of features or placement of features comprised within a given MPCM embodiment.

The MPCM 100 features a number of modular cart system component receipt features, including an axle channel 110 traversing the bottom surface 104 from the left-side 108 to the right-side 108 of the MPCM 100. Although not shown in FIG. 1, it will be understood that the axle channel 110 of MPCM 100 extends all the way across bottom surface 104 from left-side 108 to right-side 108. However, it is envisioned that some embodiments of a MPCM may comprise features that do not fully extend across a MPCM, yet are suitably configured for the receipt of an axle or other modular cart component. Turning back to axle channel 110, an axle (not shown) may be received into the channel 110 such that the MPCM 100 is positioned (front to back) substantially perpendicular to the axle. Once the axle is received into axle channel 110, the MPCM 100 may be “slid” or positioned anywhere along the axle as is desired by a user. Once the MCPM 100 is positioned on the axle, the axle may be secured to the MPCM 100 via various means known in the art including, but not limited to, U-bolts. For exemplary purposes only, and not to limit the means of securing an axle to a MPCM embodiment, a U-bolt may be positioned in communication with a received axle such that the axle rests in the “saddle” of the bolt and the ends of the bolt extend through top surface 102 of MPCM 100 at axle securing features 115. Once the U-bolts are thusly positioned, an axle may be secured to MPCM 100 via application of nuts or other means known in the art for preventing the U-bolts from retracting from axle securing features 115.

MPCM 100 is depicted such that axle channel 110 is positioned substantially in the middle of MPCM 100. It will be understood, however, that such is just for exemplary purposes and that other embodiments of an MPCM may feature an axle channel, if at all, in a position closer to one end of the particular MPCM embodiment. Further, some embodiments of a MPCM having an axle channel 110 may also include an insert component 160. Insert component 160, in lieu of an axle, may be received into axle channel 110 and secured such that the channel is reduced in size. Advantageously, by use of the insert component 160, MPCM 100 may be configured for receipt of an alternative modular cart system component to the axle such as, for example, a car rack or rail system.

Exemplary bores 120 in MPCM 100 are configured for the receipt of a modular cart system component in the form of a piece of 2×4 lumber or other components having a rectangular cross-section. Advantageously, because bores 120 are configured in a “cross,” one skilled in the art will understand that a modular cart system component having a rectangular cross-section can be securely positioned in either of two orientations relative to the MPCM 100. Importantly, although the exemplary bores 120 are depicted in a cross such that a modular cart system component having a rectangular cross-section may be oriented in one of two orientations relative to MPCM 100, such will not limit the scope of multi-orientation bores that may be comprised within a given embodiment of a particular MPCM. For example, it will be understood that other MPCM embodiments may comprise multi-orientation bores such as, but not limited to, star shaped bores that are configured for more than two orientations of a given modular cart system component. Further, it will be understood that some multi-orientation bores comprised within a given embodiment of a MPCM may be configured for orienting modular cart system component that have cross-sections other than rectangular.

Various modular cart system components may be received into bores 120, or other bores or features in a given MPCM embodiment, such that a useful support structure is created. For example, a pair of MPCMs 100 may be positioned and secured to an axle as described above. Subsequently, a series of vertical cargo support members having rectangular cross-sections may be received, respectively, into each of the four bores 120 such that the vertical cargo support members are secured in an upright and perpendicular position relative to the MPCMs. Straps, or other support means, may be secured between pairs of the vertical cargo support members such that the straps reach from the uppermost end of one support member to the uppermost end of another support member, thereby creating a pair of saddles useful for receiving a cargo.

Similar to bores 120, other component receipt features may be included in various embodiments of a MPCM. For example, MPCM 100 includes cylindrical bores 125, configured for receipt of modular cart system component having either a round cross-section or a maximum diameter less than the diameter of the bore. It will be understood that, although bores 125 are described as “cylindrical,” some system component receipt features, whether of a bore design or not, may have tapered walls or other means for convenient receipt or securing of a modular cart system component. Further, it is envisioned that while some system component receipt features may be configured to secure a modular cart system component via complimentary geometry only, other system component receipt features may include securing mechanisms such as, but not limited to, locks, magnets, pins, latches or the like.

System component receipt features 130 included in MPCM 100 are configured for receipt of a tether and washer combination. More specifically, system component receipt features 130 are comprised of “T-shaped” channels bored into the top surface 102 of MPCM 100. A pair of parallel T-channels 130 is depicted at both ends of MPCM 100. Advantageously, a tether extended through a standard washer or the like, and knotted such that the tether cannot be pulled back through the washer, can be received by a T-channel 130 such that the washer slides into the portion of the T-channel that is parallel to the plane of top surface 102. Once received into the parallel portion of T-channel 130, the tether can be used to secure cargo or other modular cart system components to the MPCM 100, as application of a pulling force on the tether will serve to pull the washer deeper into the parallel portion of the T-channel 130 thus generating a suitable anchor point for the tether.

To illustrate the multi-function aspects of various features that may be comprised within a given embodiment of a MPCM, it is envisioned that T-channel member receipt features 130 may also be useful for the receipt of a surfboard fin. In such an application, the fin of the surfboard may be slid into T-channels 130 such that the board is positioned for secure transport.

System component receipt feature 135 consists of a bore into either the front or back surfaces 106 of MPCM 100 and may be used for the secured receipt of, among other modular cart system components, a push-cart or pull-art handle assembly. In other embodiments, system component receipt feature 135 may be used to securely receive a trailer tongue assembly, dumping handle or any other modular cart system component as may be deemed useful by a user.

MPCM 100 also comprises a channel receipt feature 140 that may be used in connection with anchor points 145 to position and secure a deck, or other flatbed surface, between a pair of MPCMs. For example, a modular cart system component in the form of a deck may be simultaneously slid into the channel receipt features 140 of two or more MPCMs 100 positioned in parallel along one or more axles. The exemplary deck component, once slid into the channel receipt features 140, may thusly be secured by way of bolts or other fastening means through holes 150 or anchor point grooves 145. Advantageously, one skilled in the art will understand that a deck or similar modular cart system component that is received and secured between two or more MPCMs will serve to unify the modular cart system and provide for a useful cargo carrying surface.

MPCM 100 further features a series of anchor points 155 in the form of holes bored through a channel in the sides 108. The anchor points 155 may be used for receipt of fasteners for securing various system components or hooks, straps, tie-downs, bungees or the like for securing cargo. Anchor points 155 are depicted for exemplary purposes only and, as such, all embodiments of a MPCM may not feature such anchor points or features. Further, it will be apparent to those skilled in the art that the various features illustrated and described relative to the embodiment of FIG. 1 may be leveraged for uses beyond the exemplary uses described herein.

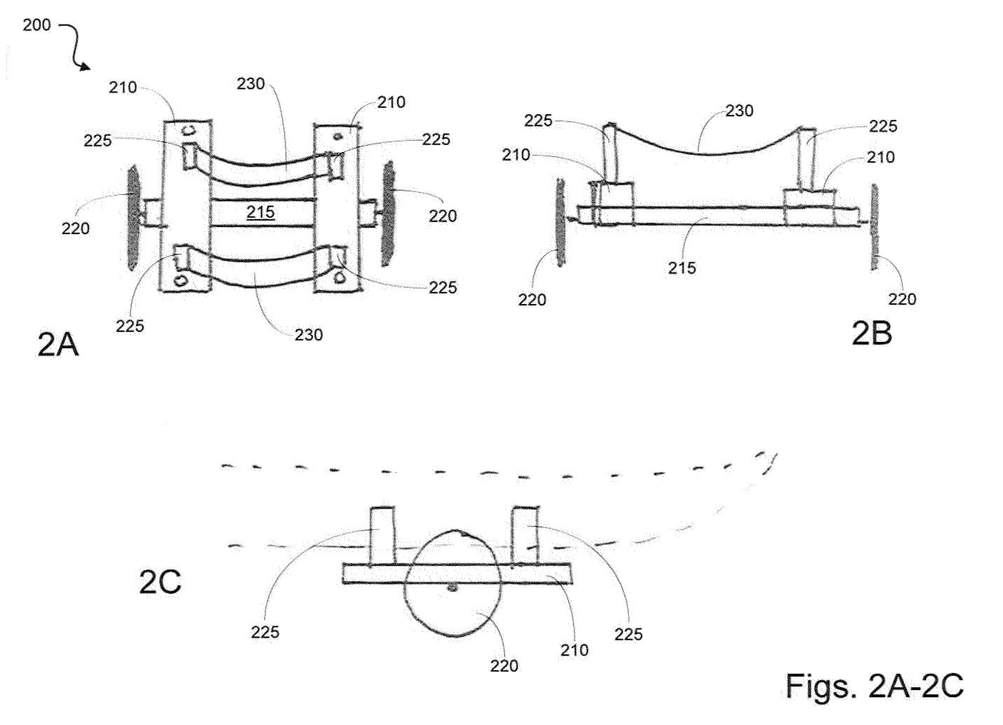

FIGS. 2A-16B are directed toward exemplary transport solutions that may be configured from various modular cart systems comprised of one or more MPCMs such as, but not limited to, MPCM 100. Figs. A-Z are offered herein for illustrative purposes only and, as such, are not intended as a comprehensive representation of all envisioned transport solutions that may be configured from a given modular cart system embodiment. Further, while various transport solution configurations, and the modular cart system components used for those configurations, may be novel in and of themselves, the transport solutions described and depicted do not limit the scope of a modular cart system comprised of a given MPCM.

FIGS. 2A-2C illustrate top, back and side views, respectively, of an exemplary strap carrier transport solution 200 configured from a modular cart system comprising a multipurpose chassis member. Referring to FIG. 2C, the form of a boat, canoe or kayak is depicted as a cargo being transported by the strap carrier solution 200. However, it will be understood that a strap carrier solution 200 may be useful for transport of other cargo besides that which is depicted.

Generally, the strap carrier transport solution 200 consists of two MPCMs 210 in communication with an axle 215 and wheels 220, as has been described relative to the FIG. 1 embodiment 100. Inserted into component receipt features of the MPCMs 210 are a series of four vertical cargo support members 225. A strap 230 may be extended between the distal ends of parallel vertical cargo support members 225 such that a saddle spans between the two MPCMs 210. While it is envisioned that some transport solutions may further comprise a component configured for pulling the modular cart system, the particular exemplary transport solution 200 serves to support cargo placed in the strap 230 saddle while a pulling force may be applied to the cargo itself.

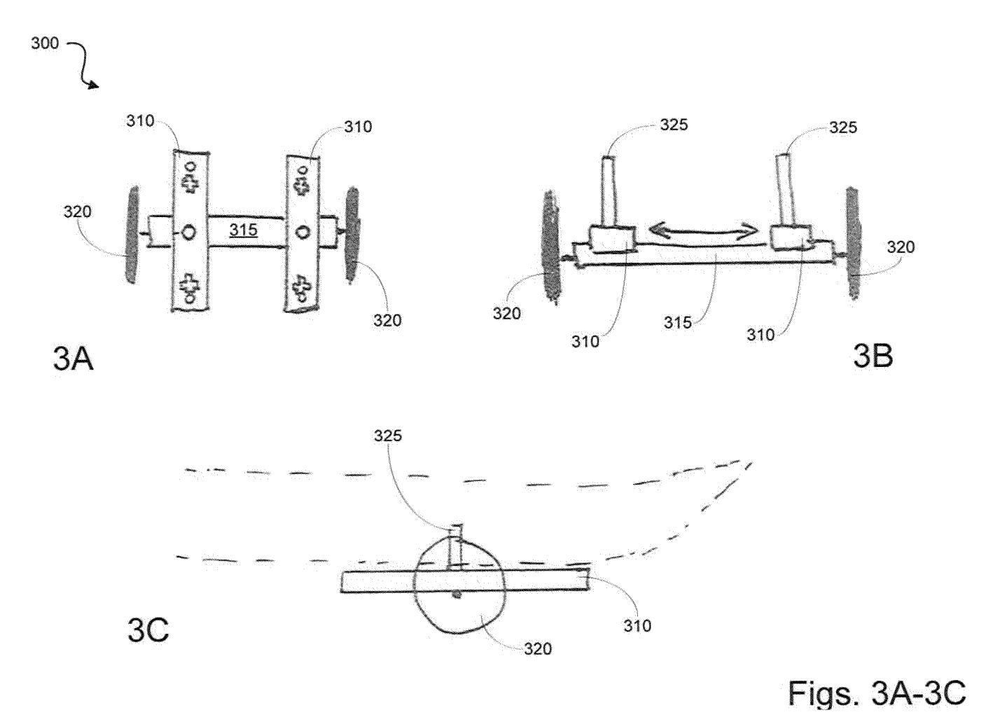

FIGS. 3A-3C illustrate top, back and side views, respectively, of an exemplary scupper carrier transport solution 300 configured from a modular cart system comprising a multipurpose chassis member. Referring to FIG. 3C, the form of a boat, canoe or kayak is depicted as a cargo being transported by the scupper carrier solution. However, it will be understood that a scupper carrier solution may be useful for transport of any cargo comprising a scupper, hole or recess.

Generally, the scupper carrier transport solution 300 consists of two MPCMs 310 in communication with an axle 315 and wheels 320, as has been described relative to the FIG. 1 embodiment 100. Inserted into component receipt features of the MPCMs 310 are a pair of vertical cargo support members 325. As can be seen in the FIG. 3B depiction, the vertical cargo support members 325 are spaced along the axle 315 such that each can be inserted through a scupper hole. While it is envisioned that some transport solutions may further comprise a component configured for pulling the modular cart system, the particular exemplary transport solution 300 serves to support cargo placed on the scupper support members 325 while a pulling force may be applied to the cargo itself.

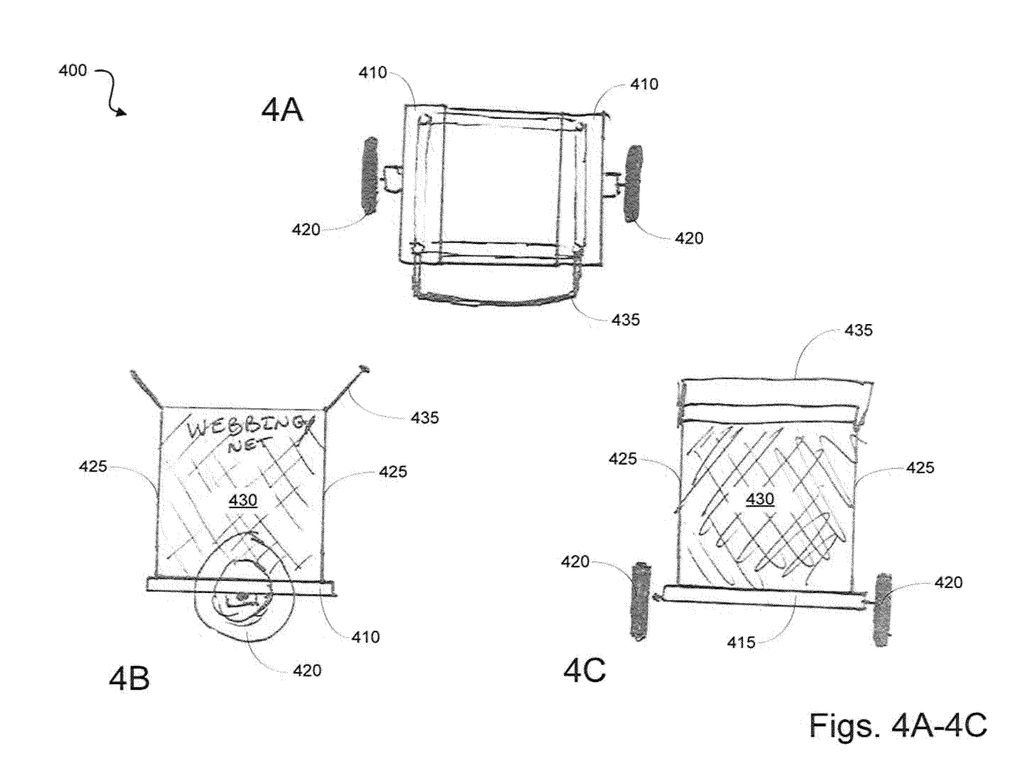

FIGS. 4A-4C illustrate top, side and front views, respectively, of an exemplary beach cart transport solution 400 configured from a modular cart system comprising a multipurpose chassis member. Generally, the beach cart transport solution 400 consists of two MPCMs 410 in communication with an axle 415 and wheels 420, as has been described relative to the FIG. 1 embodiment 100. Inserted into component receipt features of the MPCMs 410 are a series of four vertical cargo support members 425. A net or other barrier component 430 may be supported by vertical cargo support members 425 such that a cargo carrying space is defined above the two MPCMs 210. Also, a handle component 435 of the modular cart system is depicted as being either integral to or received by, as the particular embodiment may dictate, one or more vertical cargo support members 425 such that the beach cart transport solution 400 can be tilted and pulled from one location to another.

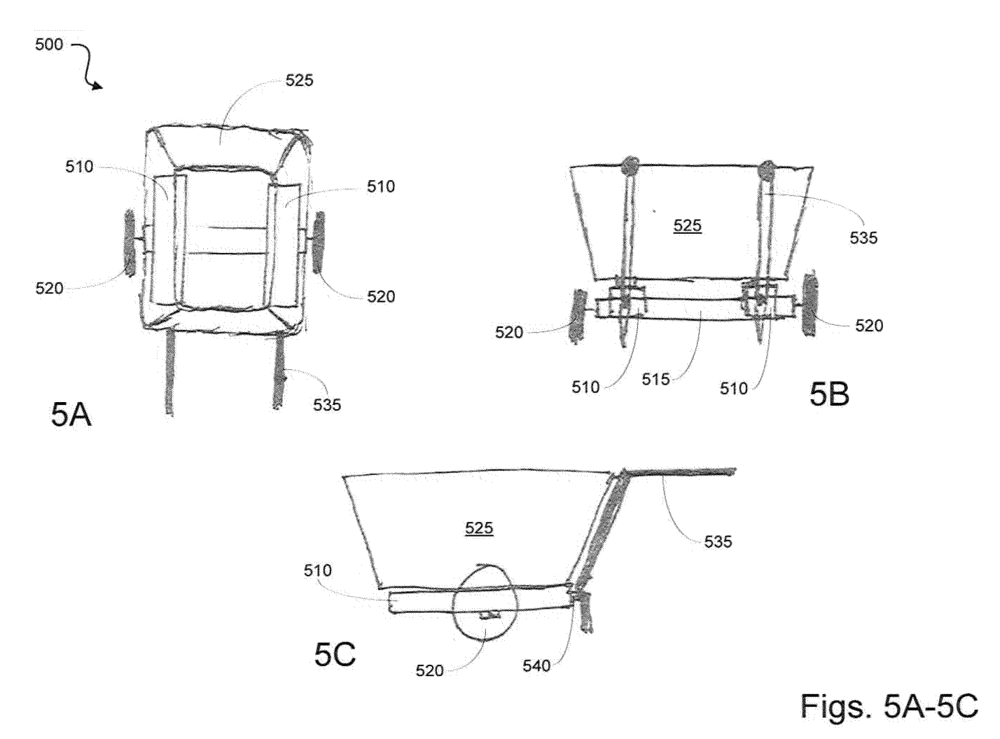

FIGS. 5A-5C illustrate top, back and side views, respectively, of an exemplary 2-wheel utility cart transport solution 500 configured from a modular cart system comprising a multipurpose chassis member. Generally, the 2-wheel utility cart transport solution 500 consists of two MPCMs 510 in communication with an axle 515 and wheels 520, as has been described relative to the FIG. 1 embodiment 100. Inserted into component receipt features of the MPCMs 510 cargo support component 525. The cargo support component 525 is supported by the two MPCMs 510. Also, a handle component 535 of the modular cart system is depicted as being received by a component receipt feature 540 of either or both of the MPCMs 510 such that the 2-wheel utility cart transport solution 500 can be tilted and pulled from one location to another.

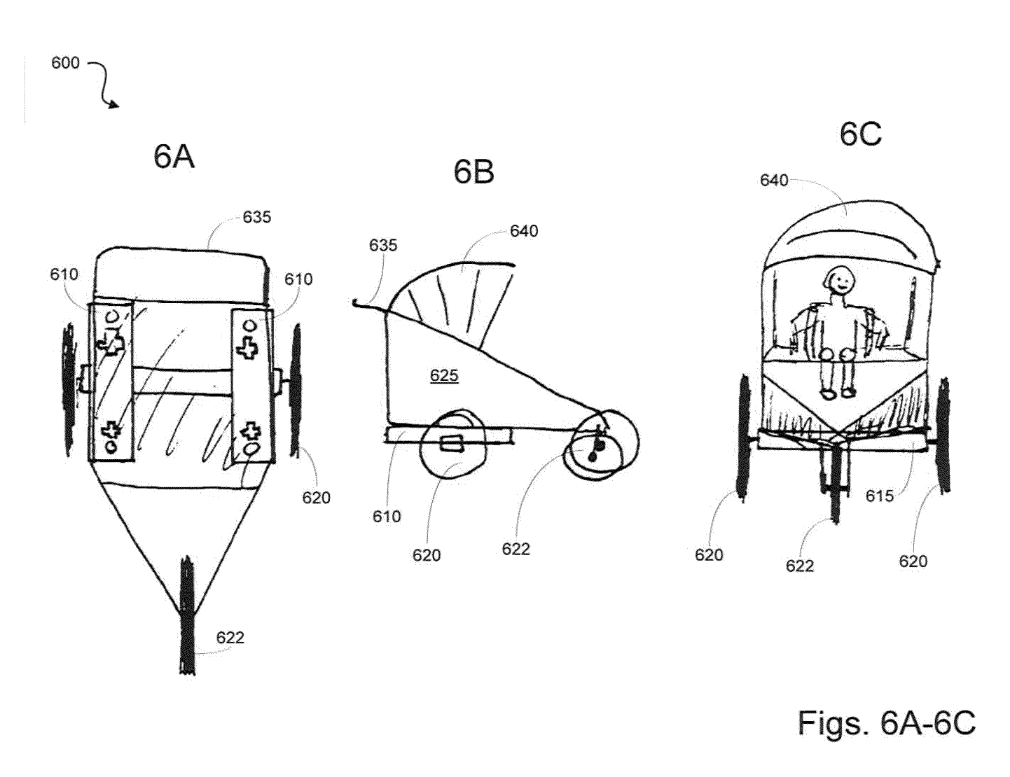

FIGS. 6A-6C illustrate top, side and front views, respectively, of an exemplary trishaw cart transport solution 600 configured from a modular cart system comprising a multipurpose chassis member. Generally, the trishaw cart transport solution 600 consists of two MPCMs 610 in communication with an axle 615 and wheels 620, as has been described relative to the FIG. 1 embodiment 100. Inserted into component receipt features of the MPCMs 610 is cargo support component 625. The cargo support component 625 is supported by the two MPCMs 610 and may be further configured to receive other modular cart system components such as, but not limited to, a retractable cover 640.

Additionally, the trishaw transport solution 600 may further include modular cart components such as a front wheel frame extension 622 which may, in some embodiments, be received by a component receipt feature of the MPCMs 610. Also, an exemplary handle component 635 of the modular cart system is depicted such that the trishaw cart transport solution 600 can be conveniently pushed from one location to another.

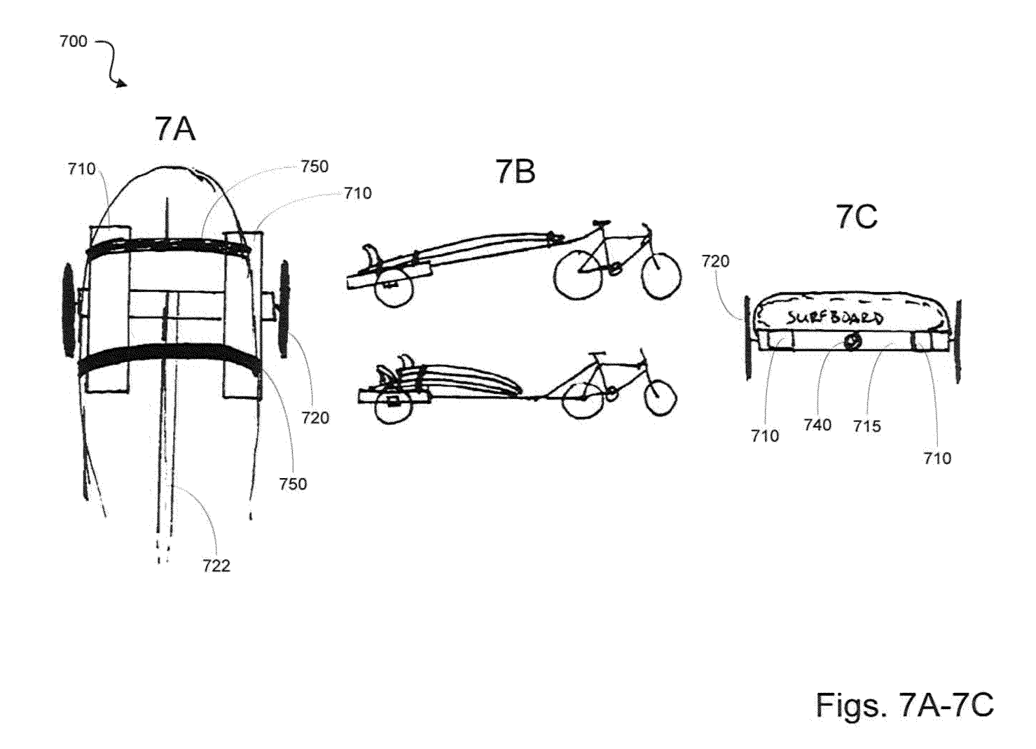

FIGS. 7A-7C illustrate top, side and front views, respectively, of an exemplary 2-wheel trailer utility cart transport solution 700 configured from a modular cart system comprising a multipurpose chassis member. Generally, the 2-wheel trailer utility cart transport solution 700 consists of two MPCMs 710 in communication with an axle 715 and wheels 720, as has been described relative to the FIG. 1 embodiment 100. Inserted into component receipt features of the MPCMs 710 or, as shown, a component receipt feature 740 of the axle 715, is a hitch extension component 722 configured for pulling the 2-wheel trailer utility cart via bike (as seen in FIG. 7B) or some other power source. Also, straps 750 are anchored via component receipt features (not shown) of the MPCMs 710 such that a cargo can be secured.

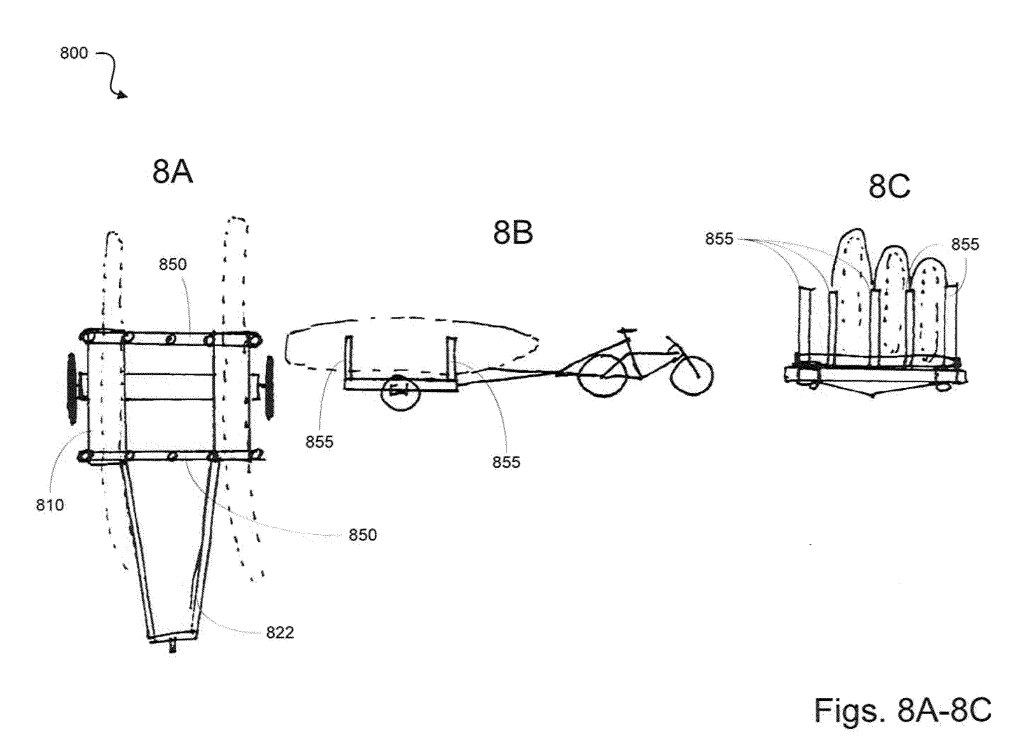

FIGS. 8A-8C illustrate top, side and front views, respectively, of an exemplary 2-wheel trailer utility cart transport solution 800 configured from a modular cart system comprising a multipurpose chassis member. Generally, the 2-wheel trailer utility cart transport solution 800 consists of two MPCMs having component receipt features configured to accommodate a pair of cross members 850 of the modular cart system. Inserted into the cross members is a series of vertical cargo support members 855 spaced apart such that cargo may be placed between them. Similar to the exemplary 2-wheel trailer utility cart transport solution depicted and described in FIGS. 7A-7C, a hitch extension component 822 configured for pulling the 2-wheel trailer utility cart via bike (as seen in FIG. 7B) or some other power source is included. The hitch extension 822 may be communicably received into a component receipt feature of the MPCMs 810 or cross member 850.

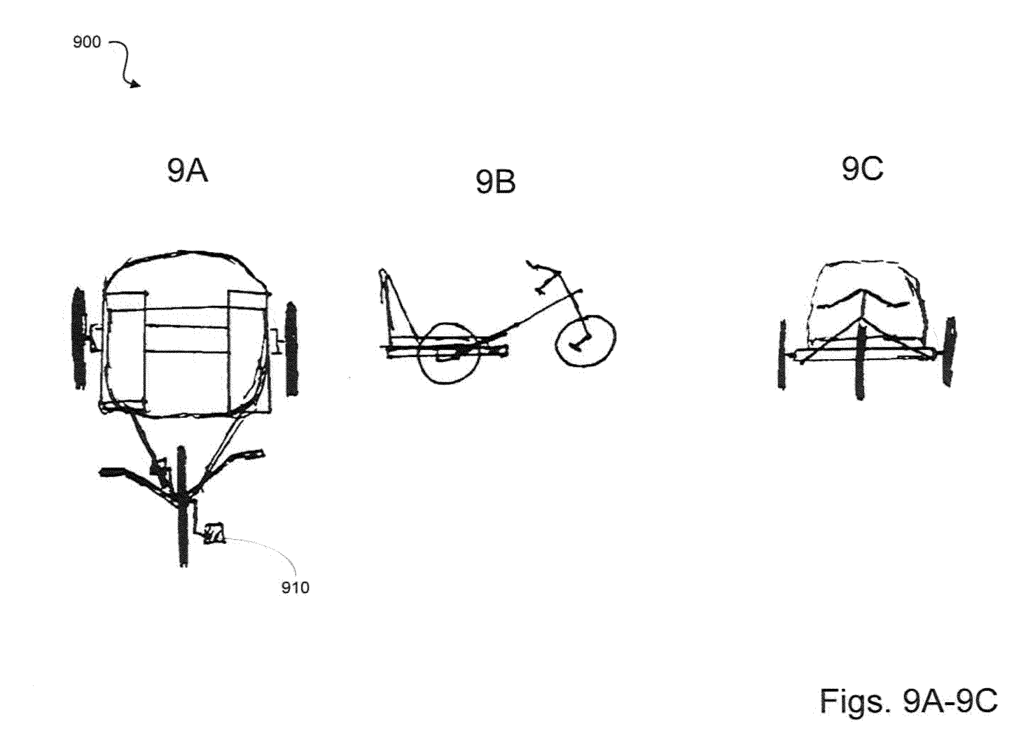

FIGS. 9A-9C illustrate top, side and front views, respectively, of an exemplary tricycle cart transport solution 900 configured from a modular cart system comprising a multipurpose chassis member. Generally, the tricycle cart transport solution 900 is similar to that which was described relative to the trishaw cart transport solution 600, further including an integrated pedal component 910.

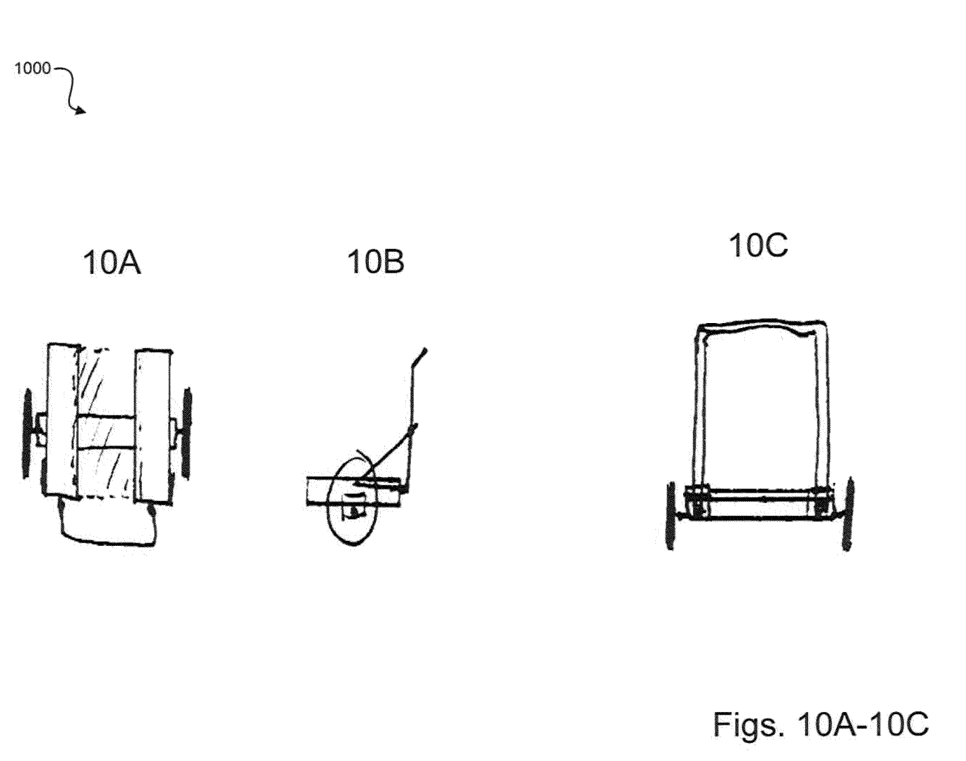

FIGS. 10A-10C illustrate top, side and front views, respectively, of an exemplary moving cart transport solution 1000 configured from a modular cart system comprising a multipurpose chassis member. Generally, the moving cart transport solution 1000 is similar to that which was described relative to other embodiments of a modular cart system comprising a MPCM and is offered herein to further illustrate an envisioned embodiment.

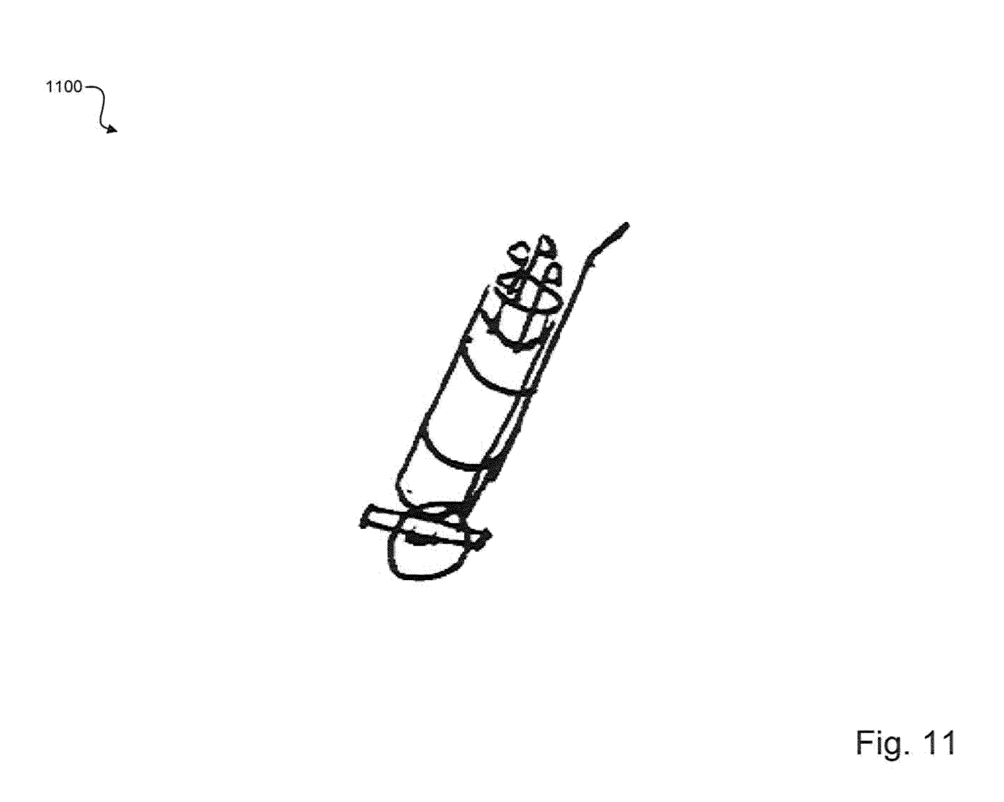

FIG. 11 illustrates an exemplary golf bag transport solution 1100 configured from a modular cart system comprising a multipurpose chassis member. Generally, the golf bag transport solution 1100 is similar to that which was described relative to other embodiments of a modular cart system comprising a MPCM and is offered herein to further illustrate an envisioned embodiment.

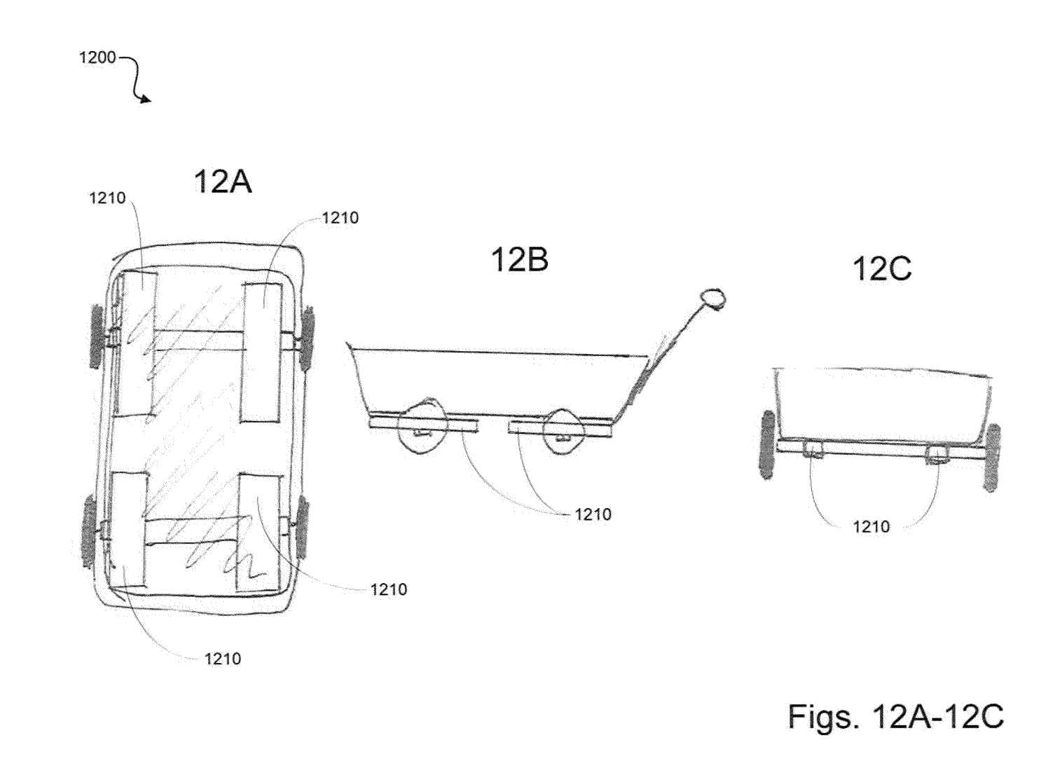

FIGS. 12A-12C illustrate top, side and front views, respectively, of an exemplary 4-wheel utility cart transport solution 1200 configured from a modular cart system comprising multipurpose chassis members. Generally, the 4-wheeled utility cart transport solution 1200 is similar to the 2-wheel utility cart transport solution 500 described relative to FIGS. 5A-5C. However, the 4-wheeled utility cart transport solution consists of four MPCMs 1210, each pair of MPCMs 1200 being in communication with a common axle. Importantly, although the 4-wheel utility cart transport solution 1200 is depicted with four MPCMs 1210, one skilled in the art will understand that essentially the same solution may be implemented with a single pair of MPCMs wherein each MPCM is configured to communicably receive two axles.

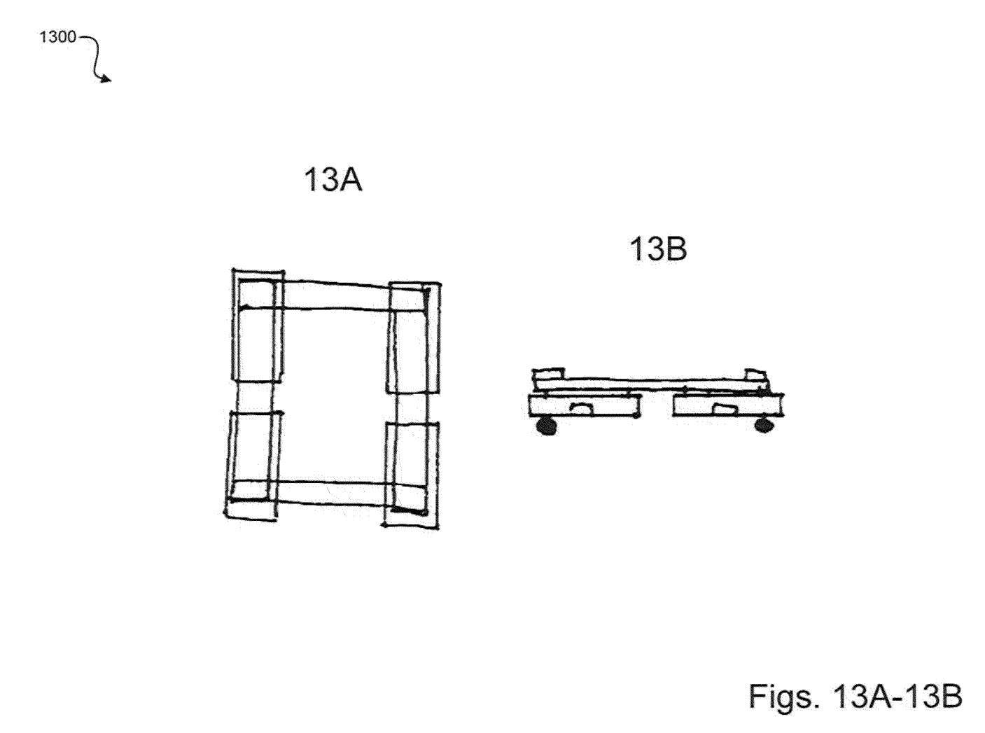

FIGS. 13A-13B illustrate top and side views, respectively, of an exemplary furniture dolly transport solution 1300 configured from a modular cart system comprising multipurpose chassis members. Generally, the furniture dolly transport solution 1300 is similar to the 4-wheel utility cart transport solution 1200 described relative to FIGS. 12A-12C. Advantageously, the various component receipt features of the MPCMs included in the modular cart system may be configured to receive casters.

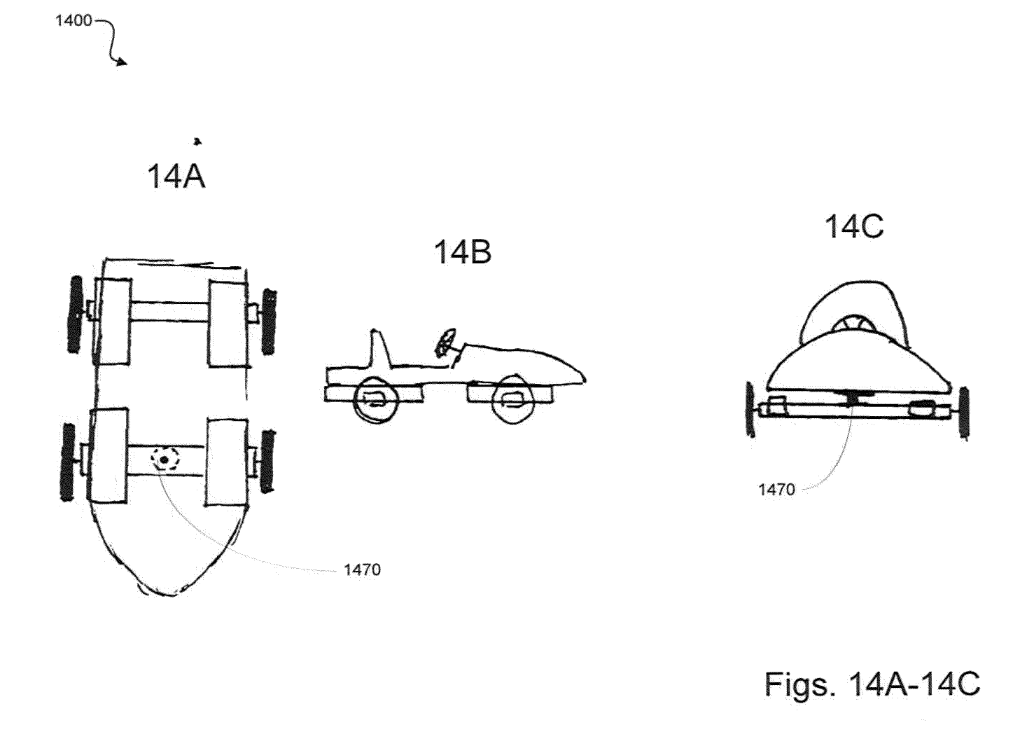

FIGS. 14A-14C illustrate top, side and front views, respectively, of an exemplary steerable go-cart transport solution 1400 configured from a modular cart system comprising multipurpose chassis members. Generally, the steerable go-cart transport solution 1400 is similar to the 4-wheel utility cart transport solution 1200 described relative to FIGS. 12A-12C. However, the steerable go-cart transport solution 1400 includes MPCMs or axle configured to receive a pivot component 1470 operable to provide for the “turning” of the front MPCM/axle combination.

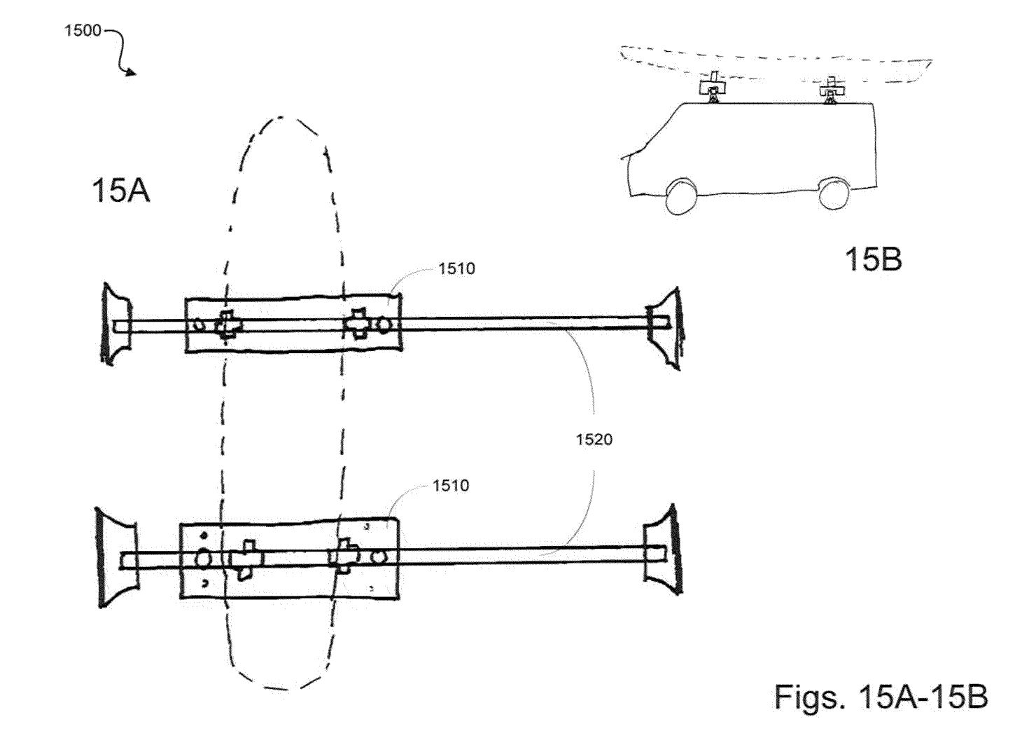

FIGS. 15A-15B illustrate top and side views, respectively, of an exemplary luggage rack transport solution 1500 configured from a modular cart system comprising multipurpose chassis members. As has been described, MPCMs may comprise any number or combination of features configured for the reception of various system components. Some MPCM 1510 embodiments may be configured such that, in lieu of an axle, a luggage rack or some other stationary component 1520 may be received. Advantageously, MPCMs 1510 that are configured to be secured to a luggage rack or the like may be decoupled from an axle and subsequently secured to a luggage rack 1520 so that cargo may be transported. Notably, Fig. B depicts the exemplary luggage rack transport solution 1500 in communication with a luggage rack on a van.

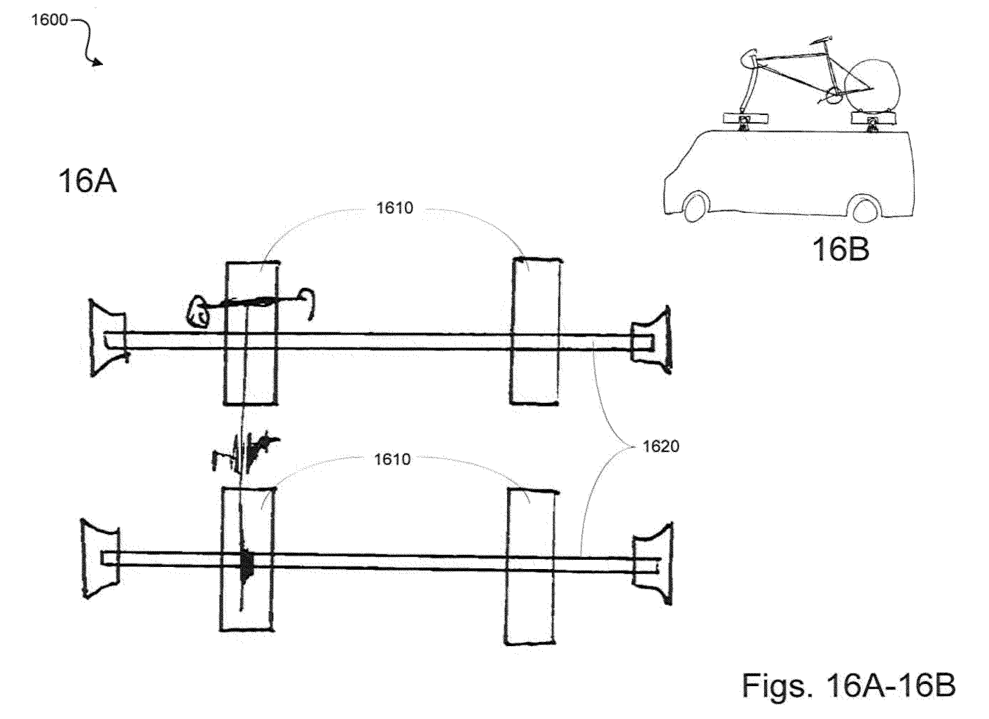

FIGS. 16A-16B illustrate top and side views, respectively, of an exemplary luggage rack transport solution 1600 configured from a modular cart system comprising multipurpose chassis members. Similar to the embodiment depicted and described relative to FIGS. 15A-15B, the luggage rack transport solution 160 is includes MPCMs 1610 configured for the receipt of a luggage rack or similar component 1620 in lieu of an axle. Notably, Fig. B depicts the exemplary luggage rack transport solution 1600 in communication with a luggage rack on a van.

Systems, devices and methods for the provision of transport solutions via modular cart systems comprising multipurpose chassis member(s) have been described using detailed descriptions of embodiments thereof that are provided by way of example and are not intended to limit the scope of the disclosure. The described embodiments comprise different features, not all of which are required in all embodiments of a multipurpose chassis member or a modular cart system comprising multipurpose chassis member(s). Some embodiments of a multipurpose chassis member or a modular cart system comprising multipurpose chassis member(s) utilize only some of the features or possible combinations of the features. Moreover, some embodiments of a multipurpose chassis member or a modular cart system comprising multipurpose chassis member(s) may be configured to provide for any number or combination of transport solutions and, as such, it will be understood that multiple multipurpose chassis members, wherein each multipurpose chassis member may utilize only some of the features or possible combinations of the features, may be reside within a single embodiment of a modular cart system. Variations of embodiments of a multipurpose chassis member or a modular cart system comprising multipurpose chassis member(s) that are described and embodiments of a multipurpose chassis member or a modular cart system comprising multipurpose chassis member(s) comprising different combinations of features noted in the described embodiments will occur to persons of the art.

It will be appreciated by persons skilled in the art that systems, devices and methods for the provision of a multipurpose chassis member or a modular cart system comprising multipurpose chassis member(s) is not limited by what has been particularly shown and described herein above. Rather, the scope of systems, devices and methods for a multipurpose chassis member or a modular cart system comprising multipurpose chassis member(s) is defined by the claims that follow.

What is claimed is:

1. A multi-purpose chassis member, comprising:
a top surface;
a bottom surface;
a front surface;
a back surface;
a left-side surface; and
a right-side surface;
wherein the multi-purpose chassis member is configured to removably receive on its top surface at least one vertical cargo support member;
wherein the multi-purpose chassis member is configured to removably receive an axle on its bottom surface;
wherein, upon receipt of an axle, the top, bottom, left-side and right-side surfaces of the multi-purpose chassis member are substantially perpendicular to the received axle; and
wherein the multi-purpose chassis member can be slidably positioned and secured at a plurality of points along the axle.

2. The multi-purpose chassis member of claim 1, configured to removably receive at least one vertical cargo support member via a bore in the top surface.

3. The multi-purpose chassis member of claim 2 having a bore in the top surface shaped in a cross.

4. The multi-purpose chassis member of claim 2 having a bore in the top surface shaped in a circle.

5. The multi-purpose chassis member of claim 1, further configured to removably couple to a frame.

6. The multi-purpose chassis member of claim 5, wherein the frame is a luggage rack on a motor vehicle.

7. The multi-purpose chassis member of claim 1, further comprising a hitch component.

8. The multi-purpose chassis member of claim 1, configured to removably receive an axle at a point substantially midway on the bottom surface.

9. A modular cart system, comprising:
an axle having a wheel communicatively coupled at each of its distal ends;
at least two vertical cargo support members, each having a first end and a second end; and
at least two multi-purpose chassis members, each comprising:
a top surface configured to removably receive the second end of at least one of said vertical cargo support members;
a bottom surface configured to removably receive said axle;
a front surface;
a back surface;
a left-side surface; and
a right-side surface;
wherein, upon receipt of said axle by the at least two multi-purpose chassis members, the top, bottom, left-side and right-side surfaces of each multi-purpose chassis member are substantially perpendicular to the received axle; and
wherein each multi-purpose chassis member can be slidably positioned and secured at a plurality of points along a received axle.

10. The modular cart system of claim 9, wherein the first ends of two of the at least two vertical cargo support members are connected via a substantially horizontal member.

11. The modular cart system of claim 10, wherein the substantially horizontal member is a strap.

12. The modular cart system of claim 9, wherein the at least two multi-purpose chassis members are configured to removably receive the second end of at least one vertical cargo support member via a bore in the top surface.

13. The modular cart system of claim 12, wherein the at least two multi-purpose chassis members have a bore in the top surface shaped in a cross.

14. The modular cart system of claim 12, wherein the at least two multi-purpose chassis members have a bore in the top surface shaped in a circle.

15. The modular cart system of claim 9, wherein at least one of the multi-purpose chassis members is further configured to removably couple to a frame.

16. The modular cart system of claim 15, wherein the frame is a luggage rack on a motor vehicle.

17. The modular cart system of claim 9, further comprising a hitch component.

18. The modular cart system of claim 9, wherein the multi-purpose chassis members are configured to removably receive the axle at a point substantially midway on the bottom surfaces.
